(19) United States
(12) Patent Application Publication
(10) Pub. No.: US 2017/0344247 A1
(43) Pub. Date: Nov. 30, 2017

(54) TOUCH SCREEN DEVICE ENABLING ENTITY TO BE SHIFTED OR COPIED BASED ON TOUCH INPUT, AND OPERATING METHOD THEREOF

(71) Applicant: HANCOM FLEXCIL, INC., Seongnam-si, Gyeonggi-do (KR)

(72) Inventors: Changil LEE, Gwangju-si, Gyeonggi-do (KR); Jihoon PARK, Seongnam-si, Gyeonggi-do (KR)

(73) Assignee: HANCOM FLEXCIL, INC., Seongnam-si, Gyeonggi-do (KR)

(21) Appl. No.: 15/529,982

(22) PCT Filed: Aug. 8, 2016
(86) PCT No.: PCT/KR2016/008715

§ 371 Date: May 25, 2017

(30) Foreign Application Priority Data
Sep. 17, 2015 (KR) 10-2015-0131490
Sep. 17, 2015 (KR) 10-2015-0131492
Dec. 4, 2015 (KR) 10-2015-0172012

(51) Int. Cl. G06F 3/0488; G06F 3/01; G06F 3/041

(52) U.S. Cl. CPC G06F 3/04883; G06F 3/0416; G06F 3/017; G06F 2203/04106

(57) ABSTRACT

A touch screen device enabling an entity to be shifted or copied based on a touch input and an operating method thereof according to exemplary embodiments of the present invention may provide a function of shifting or copying entities included in an electronic document only with an application of a simple touch input onto a touch screen by a user, thereby promoting convenience of the user who desires to write or edit the electronic document on the touch screen device.

### TECHNICAL FIELD

Exemplary embodiments of the present invention are related to technologies for providing an edit or writing function for an electronic document by recognizing a touch input of a user in a touch screen device.

### BACKGROUND ART

Recently, as portable smart devices, such as a smart phone or a tablet PC, are widely supplied, various applications utilized in the smart device are released.

Particularly, there are many cases where the smart devices are commonly mounted with touch screens, so that many applications providing interfaces based on a touch input of a user have appeared.

An operation performed by recognizing a touch input of a user in the smart device mounted with the touch screen includes a function of tracing a trace of a movement of a touch input of a user to enable a screen to be scrolled, a function of enlarging or contracting a screen based on a multi-touch input, or the like.

Recently, a function of enabling a user to write, edit, and read an electronic document is introduced in the touch screen device. Accordingly, research on a touch technology which enables a user to edit an electronic document based on a touch input in a touch screen device is actively conducted.

The existing touch screen device is designed so that in order to copy or shift (cut), by a user, an entity, such as text, a figure, and an image, displayed at a first point in an electronic document to a second point in the electronic document, the user needs to apply a touch input onto the corresponding entity, select the corresponding entity, and select a command of “copy” or “cut” in a predetermined menu image displayed on the touch screen, and then the user needs to apply a touch input onto the second point in the electronic document again and select a command of “paste” in the menu image displayed on the touch screen to copy or shift the corresponding entity.

Accordingly, in order for the user to copy or shift a specific entity displayed at the first point in the electronic document to the second point, the user needs to inconveniently apply a plurality of touch inputs and select various commands at the same time.

Accordingly, there is a need for research on a touch interface technology which is capable of providing a function of easily copying or shifting an entity only with an application of a simple touch input without a process of applying, by a user, several times of touch input and selecting various commands at the same time when the user copies or shifts the specific entity included in an electronic document displayed through a touch screen device to another point.

### SUMMARY OF THE INVENTION

### Technical Problem

The present invention has been made in an effort to provide a touch screen device enabling an entity to be shifted or copied based on a touch input, and an operating method thereof, which are capable of providing a function of shifting or copying entities included in an electronic document only with an application of a simple touch input onto a touch screen by a user, thereby promoting convenience of the user who desires to write or edit the electronic document on the touch screen device.

### Technical Solution

An exemplary embodiment of the present invention provides a touch screen device enabling an entity to be shifted or copied based on a touch input, the touch screen device including: a shift trace tracking unit which when one or more entities positioned at a first point of an electronic document among a plurality of entities included in the electronic document displayed through a touch screen are selected by an entity selection command, and then a touch input of a user is applied onto a predetermined point of the one or more entities, detects the touch input and tracks a shift trace of the touch input; a point confirming unit which stores data for the one or more entities in a temporary storage space in a memory allocated for shifting and copying the data, and then confirms a second point, at which the shift of the touch input in the electronic document ends, based on the shift trace of the touch input; and an entity shifting/copying unit which extracts the data for the one or more entities from the temporary storage space of the memory and inserts the one or more entities to the second point in the electronic document.

Another exemplary embodiment of the present invention provides a method of operating a touch screen device which enables an entity to be shifted or copied based on a touch input, the method including: when one or more entities positioned at a first point of an electronic document among a plurality of entities included in the electronic document displayed through a touch screen are selected by an entity selection command, and then a touch input of a user is applied onto a predetermined point of the one or more entities, detecting the touch input and tracking a shift trace of the touch input; storing data for the one or more entities in a temporary storage space in a memory allocated for shifting and copying the data, and then confirming a second point, at which the shift of the touch input in the electronic document ends, based on the shift trace of the touch input; and extracting the data for the one or more entities from the temporary storage space of the memory and inserting the one or more entities to the second point in the electronic document.

### Advantageous Effects

The touch screen device enabling the entity to be shifted or copied based on the touch input and the operating method thereof according to the exemplary embodiments of the present invention may provide a function of shifting or copying entities included in an electronic document only with an application of a simple touch input onto a touch screen by a user, thereby promoting convenience of the user who desires to write or edit the electronic document on the touch screen device.

### BRIEF DESCRIPTION OF THE DRAWINGS

FIG. 1 is a diagram illustrating a structure of a touch screen device enabling an entity to be shifted or copied based on a touch input according to an exemplary embodiment of the present invention.

FIGS. 2 and 3 are diagrams illustrating an operation of the touch screen device enabling the entity to be shifted or copied based on the touch input according to an exemplary embodiment of the present invention.

FIG. 4 is a flowchart illustrating a method of operating the touch screen device enabling the entity to be shifted or copied based on the touch input according to an exemplary embodiment of the present invention.

### DETAILED DESCRIPTION

The present invention may be variously modified and have various exemplary embodiments, so that specific embodiments will be illustrated in the drawings and described in detail in the detailed description. However, it is not intended to limit the present invention to the specific embodiments, and it will be appreciated that the present invention includes all modifications, equivalences, or substitutions included in the spirit and the technical scope of the present invention. In the description of respective drawings, similar reference numerals designate similar elements.

In the case where a component is referred to as being “connected” or “accessed” to another component, it should be understood that the component may not only be directly connected or accessed to the other component, but also there may exist another component between them. In contrast, when a component is referred to as being “directly connected to” or “directly accessed to” another component, it should be understood that there is no intervening component present.

Terms used in the present application are used only to describe specific exemplary embodiments, and are not intended to limit the present invention. As used herein, the singular forms are intended to include the plural forms as well, unless the context clearly indicates otherwise. In the present application, it will be appreciated that terms “including” and “having” are intended to designate the existence of characteristics, numbers, steps, operations, components, and elements described in the specification or a combination thereof, and do not exclude a possibility of the existence or addition of one or more other characteristics, numbers, steps, operations, components, and elements, or a combination thereof in advance.

All terms used herein including technical or scientific terms have the same meanings as meanings which are generally understood by those skilled in the art unless they are differently defined. It should be construed that terms defined in a generally used dictionary they have meanings matching those in the context of a related art, and the terms shall not be construed in ideal or excessively formal meanings unless they are clearly defined in the present application.

Hereinafter, exemplary embodiments of the present invention will be described in detail with reference to the accompanying drawings.

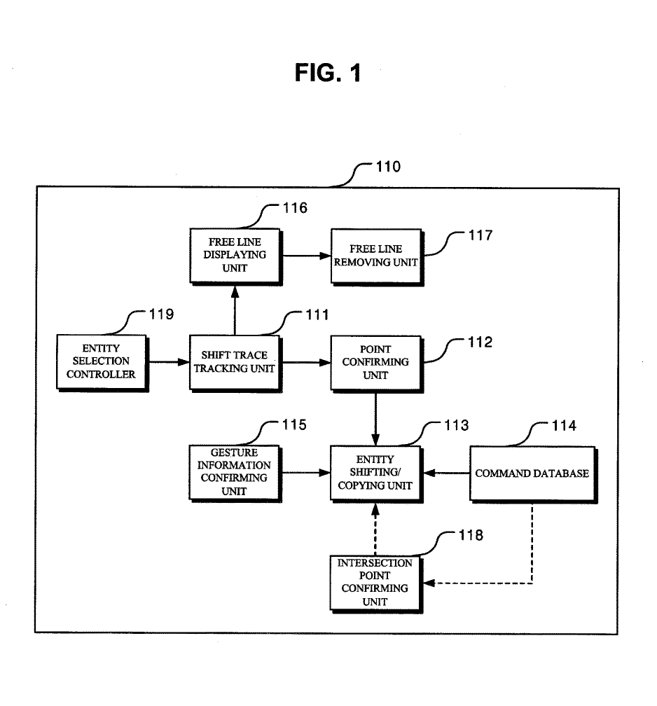

FIG. 1 is a diagram illustrating a structure of a touch screen device enabling an entity to be shifted or copied based on a touch input according to an exemplary embodiment of the present invention.

Referring to FIG. 1, a touch screen device 110 enabling an entity to be shifted or copied based on a touch input according to an exemplary embodiment of the present invention includes a shift trace tracking unit 111 111, a point confirming unit 112, and an entity shifting/copying unit 113.

When one or more entities positioned at a first point of an electronic document among a plurality of entities included in the electronic document displayed through a touch screen are selected by an entity selection command, and then a touch input of a user is applied onto a predetermined point of the one or more entities, the shift trace tracking unit 111 detects the touch input and tracks a shift trace of the touch input.

Here, the “entity” means various contents, such as text, a figure, an image, and a table, which may be included in the electronic document.

The point confirming unit 112 stores data for the one or more entities in a temporary storage space in a memory allocated for shifting and copying the data, and then confirms a second point, at which the shift of the touch input in the electronic document ends, based on the shift trace of the touch input.

The entity shifting/copying unit 113 extracts the data for the one or more entities from the temporary storage space of the memory and inserts the one or more entities to the second point in the electronic document.

In this case, according to the exemplary embodiment of the present invention, the touch screen device 110 enabling the entity to be shifted or copied based on the touch input may further include a command database 114 and a gesture information confirming unit 115.

The command database 114 stores predetermined first gesture information corresponding to an entity shift command and predetermined second gesture information corresponding to an entity copy command.

When an additional touch input is applied within a predetermined time from a time at which the application of the touch input onto the touch screen is completed, the gesture information confirming unit 115 tracks a shift trace of the additional touch input and confirms gesture information according to the shift trace of the additional touch input.

In this case, when the gesture information according to the shift trace of the additional touch input corresponds to the predetermined first gesture information, the entity shifting/copying unit 113 may extract the entity shift command from the command database 114 and simultaneously insert the one or more entities into the second point in the electronic document and delete the one or more entities positioned at the first point in the electronic document according to the entity shift command.

In this case, according to the exemplary embodiment of the present invention, when the gesture information according to the shift trace of the additional touch input corresponds to the predetermined second gesture information, the entity shifting/copying unit 113 may extract the entity copy command from the command database 114 and insert the one or more entities into the second point in the electronic document while maintaining the one or more entities positioned at the first point in the electronic document according to the entity copy command.

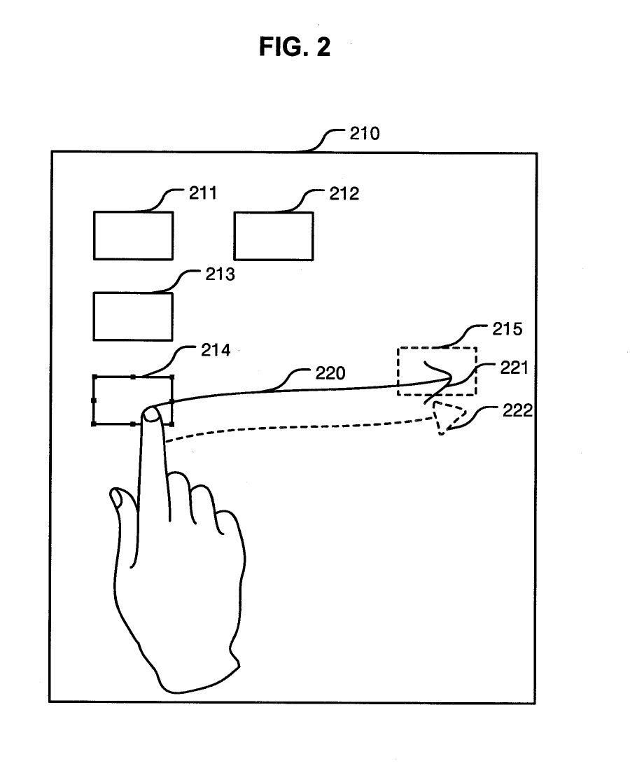

Hereinafter, an operation of the touch screen device 110 enabling the entity to be shifted or copied based on the touch input according to the present invention will be described in detail with an example with reference to FIG. 2.

As illustrated in FIG. 2, it is assumed that entity 1 211, entity 2 212, entity 3 213, and entity 4 214 are included in an electronic document 210 displayed on the touch screen as the plurality of entities.

In FIG. 2, figures are illustrated as examples of the plurality of entities, but this is a simple example for convenience of the description, and the plurality of entities is a concept including all of the various contents, such as text, an image, and a table, as well as the figure, insertable into the electronic document 210.

In this case, the user may apply a touch input onto an entity, which the user desires to select, among the entity 1 211, the entity 2 212, the entity 3 213, and the entity 4 214 to select the entity.

In this case, according to the exemplary embodiment of the present invention, the touch screen device 110 enabling the entity to be shifted or copied based on the touch input may further include an entity selection controller 119 which when two or more touch inputs are sequentially and continuously applied onto two or more entities among the plurality of entities included in the electronic document 210 within a predetermined threshold time, executes the entity selection command for the two or more entities and completes a simultaneous selection of the two or more entities.

For example, when it is assumed that the predetermined threshold time is “one second”, and when the user applies touch input 1 onto the entity 1 211 among the entity 1 211, the entity 2 212, the entity 3 213, and the entity 4 214 included in the electronic document 210, and continuously applies touch input 2 onto the entity 4 214 within “one second”, the entity selection controller 119 may execute the entity selection command for the entity 1 211 and the entity 4 214 to complete a simultaneous selection of the entity 1 211 and the entity 4 214.

When the simultaneous selection of the entity 1 211 and the entity 4 214 is completed as described above, the user applies a touch input for shifting or copying the entity to be described below to simultaneously shift or copy the entity 1 211 and the entity 4 214, and when the user executes a delete command for the entity, the entity 1 211 and the entity 4 214 may also be simultaneously deleted.

In the present exemplary embodiment, for convenience of the description, it is assumed that the entity 4 214 is selected according to the application of the touch input onto the entity 4 214 by the user.

When the entity 4 214 is selected by an entity selection command for the entity 4 214 positioned at a first point in the electronic document 210, and then the user applies a touch input onto a predetermined point of the entity 4 214 as illustrated in FIG. 2, the shift trace tracking unit 111 may track a shift trace 220 of the touch input by detecting the touch input.

The point confirming unit 112 may store data for the entity 4 214 in the temporal storage space of the memory allocated for shifting and copying data and then confirm a second point, at which the shift of the touch input ends, in the electronic document based on the shift trace 220 of the touch input.

In this case, predetermined first gesture information corresponding to an entity shift command and predetermined second gesture information corresponding to an entity copy command may be stored in the command database 114, and in the present exemplary embodiment, it is assumed that information represented in Table 1 below is stored in the command database 114.

TABLE 1

| No. | Command | Gesture information |
|---|---|---|
| 1 | Entity shift command | Gesture shaped like “>” |
| 2 | Entity copy command | Gesture shaped like “ [symbol] ” |

In this case, the gesture information confirming unit 115 may confirm whether an additional touch input is applied within a predetermined time from a time, at which the application of the touch input onto the touch screen is completed, and when an additional touch input having a trace denoted with reference numeral 221 is applied onto the touch screen as illustrated in FIG. 2, the gesture information confirming unit 115 may confirm gesture information according to the shift trace 221 of the additional touch input by tracking the shift trace 221 of the additional touch input.

In the exemplary embodiment of FIG. 2, the gesture according to the shift trace 221 of the additional touch input is the gesture shaped like “>”, so that the gesture information confirming unit 115 may confirm the gesture information shaped like “>” as the gesture information according to the shift trace 221 of the additional touch input.

In this case, since the gesture information according to the shift trace 221 of the additional touch input is the gesture information shaped like “>”, the entity shifting/copying unit 113 may extract the entity shift command from the command database 114, and insert the entity 4 214 to the second point in the electronic document 210 and simultaneously delete the entity 4 214 positioned at the first point in the electronic document 210 based on the data for the entity 4 214 stored in the temporal storage space of the memory according to the entity shift command as denoted with reference numeral 215.

That is, since the gesture information according to the shift trace 221 of the additional touch input is the gesture information shaped like “>”, the entity shifting/copying unit 113 may perform an operation of “cutting” the entity 4 214 positioned at the first point in the electronic document 210, and then perform an operation of “pasting” the entity 4 214 on the second point in the electronic document 210 as denoted with reference numeral 215.

When the shift trace according to the additional touch input has a shape of “ [symbol] ” as denoted with reference numeral 222, not the shape “>” as denoted with reference numeral 221, the gesture information confirming unit 115 may track the shift trace 222 of the additional touch input and confirm the gesture information shaped like “ [symbol] ” as the gesture information according to the shift trace 222 of the additional touch input.

In this case, since the gesture information according to the shift trace 222 of the additional touch input is the gesture information shaped like “ [symbol] ”, the entity shifting/copying unit 113 may extract the entity copy command from the command database 114, and insert the entity 4 214 to the second point in the electronic document 210 based on the data for the entity 4 214 stored in the temporal storage space of the memory as denoted with reference numeral 215 while maintaining the entity 4 214 positioned at the first point in the electronic document 210 according to the entity copy command.

That is, since the gesture information according to the shift trace 222 of the additional touch input is the gesture information shaped like “ [symbol] ”, the entity shifting/copying unit 113 may perform an operation of “copying” the entity 4 214 positioned at the first point in the electronic document 210, and then perform an operation of “pasting” the entity 4 214 on the second point in the electronic document 210 as denoted with reference numeral 215.

Finally, the touch screen device 110 enabling the entity to be shifted or copied based on the touch input according to the exemplary embodiment of the present invention is capable of providing a function of shifting or copying the entities included in the electronic document 210 only with an application of a simple touch input onto the touch screen by the user, thereby promoting convenience of the user who desires to write or edit the electronic document 210 on the touch screen device.

In this case, according to the exemplary embodiment of the present invention, the touch screen device 110 enabling the entity to be shifted or copied based on the touch input may further include a free line displaying unit 116 which when the touch input and the additional touch input are applied for shifting or copying the entity 4 214 on the touch screen, as illustrated in FIG. 2, may display a free line according to the shift trace 220 of the touch input on the touch screen based on the shift trace 220 of the touch input, and display a free line according to the shift trace 221 of the additional touch input based on the shift trace 221 of the additional touch input.

The touch screen device 110 enabling the entity to be shifted or copied based on the touch input may further include a free line removing unit 117 which when the insertion of the entity 4 214 into the second point in the electronic document 210 is completed, removes the display of the free lines.

Accordingly, the user may confirm the type of touch input applied onto the touch screen.

According to the foregoing exemplary embodiment, the present invention has been described based on the case where only the entity shift command and the entity copy command are stored in the command database 114, but according to another exemplary embodiment of the present invention, predetermined third gesture information corresponding to a command, by which a size of the entity is changed while the entity is copied, may be additionally stored or predetermined fourth gesture information corresponding to a command, by which a color of the entity is changed while the entity is shifted, may be additionally stored in the command database 114, as well as the entity shift command and the entity copy command.

Accordingly, when the user applies the additional touch input corresponding to the predetermined third gesture information or the predetermined fourth gesture information onto the touch screen, the entity shifting/copying unit 113 may control a size of the entity 4 214 to be changed while copying the entity 4 214 to the second point in the electronic document 210 in accordance with the predetermined third gesture information, and change a color of the entity 4 214 while shifting the entity 4 214 to the second point in the electronic document 210 in accordance with the predetermined fourth gesture information.

Until now, the exemplary embodiment, in which the touch screen device 110 enabling the entity to be shifted or copied based on the touch input according to the present invention provides the function of shifting or copying the entity based on the touch input and the additional touch input has been described with reference to FIG. 2.

In relation to this, the touch screen device 110 enabling the entity to be shifted or copied based on the touch input according to the present invention may include another additional exemplary embodiment for providing a function of shifting or copying an entity, and an additional structure of another additional exemplary embodiment will be continuously described with reference to FIG. 1.

According to the exemplary embodiment of the present invention, the touch screen device 110 enabling the entity to be shifted or copied based on the touch input may include the free line displaying unit 116 and the free line removing unit 117.

The free line displaying unit 116 displays a free line according to the shift trace of the touch input on the touch screen based on the shift trace of the touch input.

When the insertion of the one or more entities into the second point in the electronic document is completed, the free line removing unit 117 removes a display of the free line.

In this case, according to the exemplary embodiment of the present invention, the touch screen device 110 enabling the entity to be shifted or copied based on the touch input may further include the command database 114 in which the number of predetermined first intersection points corresponding to the entity shift command and the number of predetermined second intersection points corresponding to the entity copy command are stored, and an intersection point confirming unit 118 which when the free line is displayed on the touch screen, counts the number of intersection points generated through the free line.

In this case, when the number of intersection points generated through the free line corresponds to the number of predetermined first intersection points, the entity shifting/copying unit 113 may extract the entity shift command from the command database 114, and simultaneously insert the one or more entities into the second point in the electronic document and delete the one or more entities positioned at the first point in the electronic document according to the entity shift command.

According to the exemplary embodiment of the present invention, when the number of intersection points generated through the free line corresponds to the number of predetermined second intersection points, the entity shifting/copying unit 113 may extract the entity copy command from the command database 114, and insert the one or more entities into the second point in the electronic document while maintaining the one or more entities positioned at the first point in the electronic document according to the entity copy command.

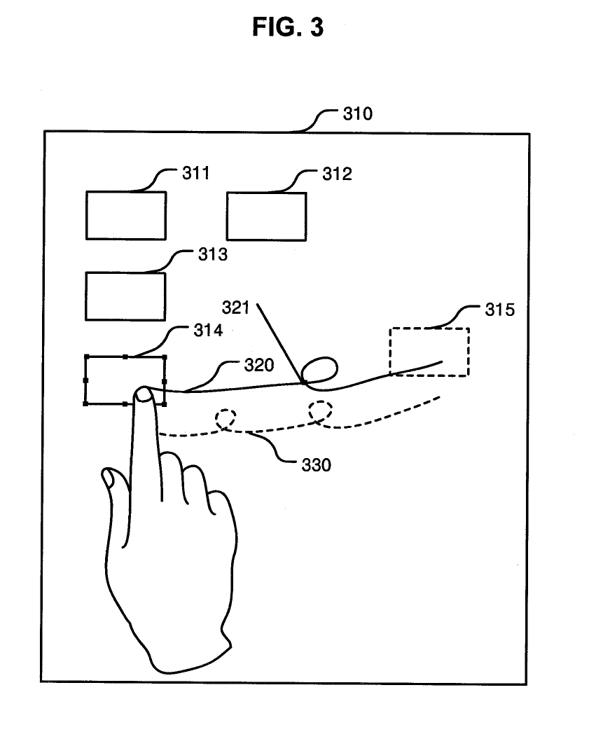

Hereinafter, an operation of the touch screen device 110 enabling the entity to be shifted or copied based on the touch input according to the present invention according to another exemplary embodiment will be described in detail with an example with reference to FIG. 3.

As illustrated in FIG. 3, it is assumed that entity 1 311, entity 2 312, entity 3 313, and entity 4 314 are included in an electronic document 310 displayed on a touch screen as the plurality of entities.

In this case, a user may apply a touch input onto an entity, which the user desires to select, among the entity 1 311, the entity 2 312, the entity 3 313, and the entity 4 314 to select the entity.

In the present exemplary embodiment, for convenience of the description, it is assumed that the entity 4 314 is selected according to the application of the touch input onto the entity 4 314 by the user.

When the entity 4 314 is selected by an entity selection command for the entity 4 314 positioned at a first point in the electronic document 310, and then the user applies a touch input onto a predetermined point of the entity 4 314 as illustrated in FIG. 3, the shift trace tracking unit 111 may track a shift trace 320 of the touch input by detecting the touch input.

The point confirming unit 112 may store data for the entity 4 314 in the temporal storage space of the memory allocated for shifting and copying data and then confirm a second point, at which the shift of the touch input ends, in the electronic document based on the shift trace 320 of the touch input.

In this case, the free line displaying unit 116 may display a free line according to the shift trace 320 of the touch input on the touch screen based on the shift trace 320 of the touch input.

In this case, the number of predetermined first intersection points corresponding to the entity shift command and the number of predetermined second intersection points corresponding to the entity copy command may be stored in the command database 114, and in the present exemplary embodiment, it is assumed that information represented in Table 2 below is stored in the command database 114.

TABLE 2

| No. | Command | Number of intersection points |
|---|---|---|
| 1 | Entity shift command | One |
| 2 | Entity copy command | Two |

In this case, when the free line according to the shift trace 320 of the touch input is displayed on the touch screen, the intersection point confirming unit 118 may count the number of intersection points generated through the free line, and in the exemplary embodiment of FIG. 3, the number of intersection points 321 presented on the free line according to the shift trace 320 of the touch input is “one”, so that the intersection point confirming unit 118 may count the number of intersection points 321 generated through the free line as “one”.

In this case, since the number of intersection points 321 generated through the free line is “one”, the entity shifting/copying unit 113 may extract the entity shift command from the command database 114, and insert the entity 4 314 to the second point in the electronic document 310 and simultaneously delete the entity 4 314 positioned at the first point in the electronic document 310 based on the data for the entity 4 314 stored in the temporal storage space of the memory according to the entity shift command as denoted with reference numeral 315.

That is, since the number of intersection points 321 generated through the free line is “one”, the entity shifting/copying unit 113 may perform an operation of “cutting” the entity 4 314 positioned at the first point in the electronic document 310, and then perform an operation of “pasting” the entity 4 314 on the second point in the electronic document 310 as denoted with reference numeral 315.

When the number of intersection points 321 generated through the free line is “two” as denoted with reference numeral 330, not “one” as denoted with reference numeral 320, the intersection point confirming unit 118 may confirm that the number of intersection points generated through the free line is “two”.

In this case, since the number of intersection points generated through the free line is “two”, the entity shifting/copying unit 113 may extract the entity copy command from the command database 114, and insert the entity 4 314 to the second point in the electronic document 310 based on the data for the entity 4 314 stored in the temporal storage space of the memory as denoted with reference numeral 315 while maintaining the entity 4 314 positioned at the first point in the electronic document 310 according to the entity copy command.

That is, since the number of intersection points generated through the free line is “two”, the entity shifting/copying unit 113 may perform an operation of “copying” the entity 4 314 positioned at the first point in the electronic document 310, and then perform an operation of “pasting” the entity 4 314 on the second point in the electronic document 310 as denoted with reference numeral 315.

Finally, the touch screen device 110 enabling the entity to be shifted or copied based on the touch input according to the exemplary embodiment of the present invention is capable of providing a function of shifting or copying the entities included in the electronic document 310 only with an application of a simple touch input onto the touch screen by the user, thereby promoting convenience of the user who desires to write or edit the electronic document 310 on the touch screen device.

Until now, according to the exemplary embodiment described with reference to FIG. 3, the present invention has been described based on the case where only the entity shift command and the entity copy command are stored in the command database 114, but according to another exemplary embodiment of the present invention, the number of predetermined third intersection points corresponding to a command, by which a size of the entity is changed while the entity is copied, may be additionally stored or the number of predetermined fourth intersection points corresponding to a command, by which a color of the entity is changed while the entity is shifted, may be additionally stored in the command database 114, as well as the entity shift command and the entity copy command.

Accordingly, when the user applies the touch input having the shift trace including the number of intersection points corresponding to the number of predetermined third intersection points or the number of predetermined fourth intersection points onto the touch screen, the entity shifting/copying unit 113 may control a size of the entity 4 314 to be changed while copying the entity 4 314 to the second point in the electronic document 310 in accordance with the number of predetermined third intersection points, and change a color of the entity 4 314 while shifting the entity 4 314 to the second point in the electronic document 310 in accordance with the number of predetermined fourth intersection points.

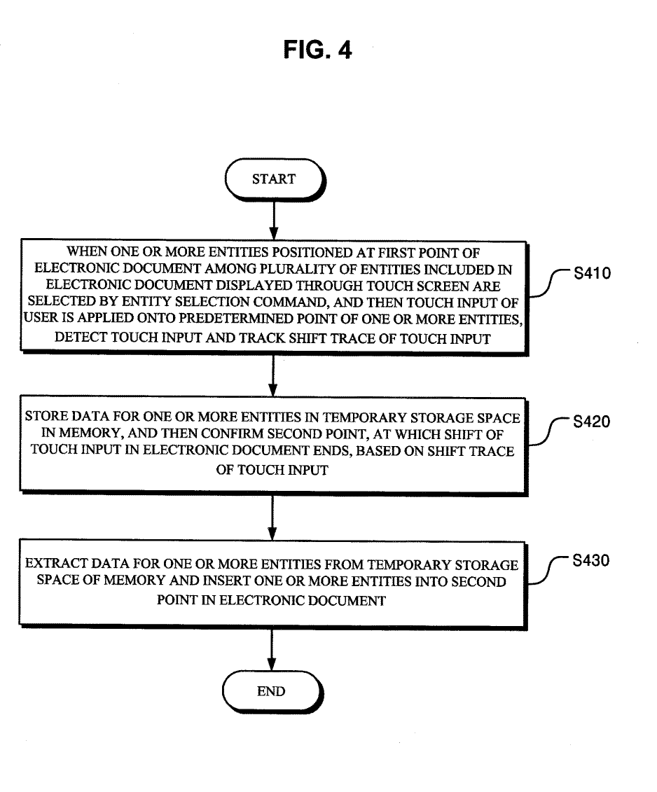

FIG. 4 is a flowchart illustrating a method of operating the touch screen device enabling the entity to be shifted or copied based on the touch input according to an exemplary embodiment of the present invention.

In operation S410, when one or more entities positioned at a first point of an electronic document among a plurality of entities included in the electronic document displayed through a touch screen are selected by an entity selection command, and then a touch input of a user is applied onto a predetermined point of the one or more entities, the touch input is detected and a shift trace of the touch input is tracked.

In operation S420, data for the one or more entities is stored in a temporary storage space in a memory allocated for shifting and copying the data, and then a second point, at which the shift of the touch input in the electronic document ends, is confirmed based on the shift trace of the touch input.

In operation S430, the data for the one or more entities is extracted from the temporary storage space of the memory and the one or more entities are inserted into the second point in the electronic document.

In this case, according to the exemplary embodiment of the present invention, the method of operating the touch screen device enabling the entity to be shifted or copied based on the touch input may further include an operation of maintaining a command database in which predetermined first gesture information corresponding to an entity shift command and predetermined second gesture information corresponding to an entity copy command are stored, and an operation of when an additional touch input is applied within a predetermined time from a time at which the application of the touch input onto the touch screen is completed, tracking a shift trace of the additional touch input and confirming gesture information according to the shift trace of the additional touch input, before the operation S430.

In this case, the operation S430 may include an operation of when the gesture information according to the shift trace of the additional touch input corresponds to the predetermined first gesture information, extracting the entity shift command from the command database and simultaneously inserting the one or more entities into the second point in the electronic document and deleting the one or more entities positioned at the first point in the electronic document according to the entity shift command.

In this case, according to the exemplary embodiment of the present invention, the operation S430 may further include an operation of when the gesture information according to the shift trace of the additional touch input corresponds to the predetermined second gesture information, extracting the entity copy command from the command database and inserting the one or more entities into the second point in the electronic document while maintaining the one or more entities positioned at the first point in the electronic document according to the entity copy command.

According to the exemplary embodiment of the present invention, the method of operating the touch screen device enabling the entity to be shifted or copied based on the touch input may further include an operation of displaying a free line according to the shift trace of the touch input on the touch screen based on the shift trace of the touch input after the operation S410, and an operation of deleting the display of the free line when the insertion of the one or more entities into the second point in the electronic document is completed after the operation S430.

In this case, according to the exemplary embodiment of the present invention, the method of operating the touch screen device enabling the entity to be shifted or copied based on the touch input may further include an operation of maintaining the command database in which the number of predetermined first intersection points corresponding to the entity shift command and the number of predetermined second intersection points corresponding to the entity copy command are stored before the operation S430, and an operation of, when the free line is displayed on the touch screen, counting the number of intersection points generated through the free line.

In this case, the operation S430 may include an operation of, when the number of intersection points generated through the free line corresponds to the number of predetermined first intersection points, extracting the entity shift command from the command database, and simultaneously inserting the one or more entities into the second point in the electronic document and deleting the one or more entities positioned at the first point in the electronic document according to the entity shift command.

In this case, according to the exemplary embodiment of the present invention, the operation S430 may further include an operation of, when the number of intersection points generated through the free line corresponds to the number of predetermined second intersection points, extracting the entity copy command from the command database, and inserting the one or more entities into the second point in the electronic document while maintaining the one or more entities positioned at the first point in the electronic document according to the entity copy command.

According to the exemplary embodiment of the present invention, the method of operating the touch screen device enabling the entity to be shifted or copied based on the touch input may further include an operation of, when two or more touch inputs are sequentially and continuously applied onto two or more entities among the plurality of entities included in the electronic document within a predetermined threshold time, executing the entity selection command for the two or more entities and completing a simultaneous selection of the two or more entities, before the operation S410.

In the foregoing, the method of operating the touch screen device enabling the entity to be shifted or copied based on the touch input according to the exemplary embodiment of the present invention has been described with reference to FIG. 4. Herein, the method of operating the touch screen device enabling the entity to be shifted or copied based on the touch input according to the exemplary embodiment of the present invention may correspond to the configuration of the operation of the touch screen device 110 enabling the entity to be shifted or copied based on the touch input described with reference to FIGS. 1 to 3, so that a more detailed description thereof will be omitted.

The method of operating the touch screen device enabling the entity to be shifted or copied based on the touch input according to the exemplary embodiment of the present invention may be implemented by a computer program stored in a storage medium for executing the method through a cooperation with a computer.

The method of operating the touch screen device enabling the entity to be shifted or copied based on the touch input according to the exemplary embodiment of the present invention may be implemented in a form of a program command executable through various computer means and may be recorded in a computer readable medium. The computer readable medium may include one or a combination of a program command, a data file, and a data structure. The program command recorded in the medium may be specially designed and configured for the present invention, or may be publicly known to and used by those skilled in the computer software field. Examples of the computer readable recording medium include a magnetic medium, such as a hard disk, a floppy disk, or a magnetic tape, an optical recording medium, such as a CD-ROM or a DVD, a magneto-optical medium, such as a floptical disk, and a hardware device which is specifically configured to store and execute the program command such as a ROM, a RAM, and a flash memory. An example of the program command includes a high-level language code executable by a computer by using an interpreter, and the like, as well as a machine language code created by a compiler. The hardware device may be configured to be operated with one or more software modules in order to perform the operation of the present invention, and an opposite situation thereof is available.

As described above, the present invention has been described by the specific matters, such as a specific component, limited embodiments, and drawings, but these are provided for helping general understanding of the present invention, and the present invention is not limited to the exemplary embodiments, and those skilled in the art will appreciate that various modifications, additions and substitutions are possible from the disclosure.

The spirit of the present invention is defined by the appended claims rather than by the description preceding them, and all changes and modifications that fall within metes and bounds of the claims, or equivalents of such metes and bounds are therefore intended to be embraced by the range of the spirit of the present invention.

1. A touch screen device enabling an entity to be shifted or copied based on a touch input, the touch screen device comprising:
a shift trace tracking unit which when one or more entities positioned at a first point of an electronic document among a plurality of entities included in the electronic document displayed through a touch screen are selected by an entity selection command, and then a touch input of a user is applied onto a predetermined point of the one or more entities, detects the touch input and tracks a shift trace of the touch input;
a point confirming unit which stores data for the one or more entities in a temporary storage space in a memory allocated for shifting and copying the data, and then confirms a second point, at which the shift of the touch input in the electronic document ends, based on the shift trace of the touch input; and
an entity shifting/copying unit which extracts the data for the one or more entities from the temporary storage space of the memory and inserts the one or more entities to the second point in the electronic document.

2. The touch screen device of claim 1, further comprising:
a command database which stores predetermined first gesture information corresponding to an entity shift command and predetermined second gesture information corresponding to an entity copy command; and
a gesture information confirming unit which when an additional touch input is applied within a predetermined time from a time, at which the application of the touch input onto the touch screen is completed, tracks a shift trace of the additional touch input and confirms gesture information according to the shift trace of the additional touch input,
wherein when the gesture information according to the shift trace of the additional touch input corresponds to the predetermined first gesture information, the entity shifting/copying unit extracts the entity shift command from the command database, and simultaneously inserts the one or more entities into the second point in the electronic document and deletes the one or more entities positioned at the first point in the electronic document according to the entity shift command.

3. The touch screen device of claim 2, wherein when the gesture information according to the shift trace of the additional touch input corresponds to the predetermined second gesture information, the entity shifting/copying unit extracts the entity copy command from the command database and inserts the one or more entities into the second point in the electronic document while maintaining the one or more entities positioned at the first point in the electronic document according to the entity copy command.

4. The touch screen device of claim 1, further comprising:
a free line displaying unit which displays a free line according to the shift trace of the touch input on the touch screen based on the shift trace of the touch input; and
a free line removing unit which when the insertion of the one or more entities into the second point in the electronic document is completed, removes the display of the free line.

5. The touch screen device of claim 4, further comprising:
a command database which stores the number of predetermined first intersection points corresponding to the entity shift command and the number of predetermined second intersection points corresponding to the entity copy command are stored; and
an intersection point confirming unit which when the free line is displayed on the touch screen, counts the number of intersection points generated through the free line,
wherein when the number of intersection points generated through the free line corresponds to the number of predetermined first intersection points, the entity shifting/copying unit extracts the entity shift command from the command database, and simultaneously inserts the one or more entities into the second point in the electronic document and deletes the one or more entities positioned at the first point in the electronic document according to the entity shift command.

6. The touch screen device of claim 5, wherein when the number of intersection points generated through the free line corresponds to the number of predetermined second intersection points, the entity shifting/copying unit extracts the entity copy command from the command database, and inserts the one or more entities into the second point in the electronic document while maintaining the one or more entities positioned at the first point in the electronic document according to the entity copy command.

7. The touch screen device of claim 1, further comprising:
an entity selection controller which when two or more touch inputs are sequentially and continuously applied onto two or more entities among the plurality of entities included in the electronic document within a predetermined threshold time, executes the entity selection command for the two or more entities and completes a simultaneous selection of the two or more entities.

8. A method of operating a touch screen device which enables an entity to be shifted or copied based on a touch input, the method comprising:
when one or more entities positioned at a first point of an electronic document among a plurality of entities included in the electronic document displayed through a touch screen are selected by an entity selection command, and then a touch input of a user is applied onto a predetermined point of the one or more entities, detecting the touch input and tracking a shift trace of the touch input;
storing data for the one or more entities in a temporary storage space in a memory allocated for shifting and copying the data, and then confirming a second point, at which the shift of the touch input in the electronic document ends, based on the shift trace of the touch input; and
extracting the data for the one or more entities from the temporary storage space of the memory and inserting the one or more entities to the second point in the electronic document.

9. The method of claim 8, further comprising:
maintaining a command database, in which predetermined first gesture information corresponding to an entity shift command and predetermined second gesture information corresponding to an entity copy command are stored; and
when an additional touch input is applied within a predetermined time from a time, at which the application of the touch input onto the touch screen is completed, tracking a shift trace of the additional touch input and confirming gesture information according to the shift trace of the additional touch input,
wherein the inserting of the one or more entities includes, when the gesture information according to the shift trace of the additional touch input corresponds to the predetermined first gesture information, extracting the entity shift command from the command database, and simultaneously inserting the one or more entities into the second point in the electronic document and deleting the one or more entities positioned at the first point in the electronic document according to the entity shift command.

10. The method of claim 9, wherein the insertion of the one or more entities further includes, when the gesture information according to the shift trace of the additional touch input corresponds to the predetermined second gesture information, extracting the entity copy command from the command database and inserting the one or more entities into the second point in the electronic document while maintaining the one or more entities positioned at the first point in the electronic document according to the entity copy command.

11. The method of claim 8, further comprising:
displaying a free line according to the shift trace of the touch input on the touch screen based on the shift trace of the touch input; and
when the insertion of the one or more entities into the second point in the electronic document is completed, removing the display of the free line.

12. The method of claim 11, further comprising:
maintaining a command database which stores the number of predetermined first intersection points corresponding to the entity shift command and the number of predetermined second intersection points corresponding to the entity copy command; and
when the free line is displayed on the touch screen, counting the number of intersection points generated through the free line,
wherein the inserting of the one or more entities includes, when the number of intersection points generated through the free line corresponds to the number of predetermined first intersection points, extracting the entity shift command from the command database, and simultaneously inserting the one or more entities into the second point in the electronic document and deleting the one or more entities positioned at the first point in the electronic document according to the entity shift command.

13. The method of claim 12, wherein the inserting of the one or more entities further includes, when the number of intersection points generated through the free line corresponds to the number of predetermined second intersection points, extracting the entity copy command from the command database, and inserting the one or more entities into the second point in the electronic document while maintaining the one or more entities positioned at the first point in the electronic document according to the entity copy command.

14. The method of claim 8, further comprising:
when two or more touch inputs are sequentially and continuously applied onto two or more entities among the plurality of entities included in the electronic document within a predetermined threshold time, executing the entity selection command for the two or more entities and completing a simultaneous selection of the two or more entities.

15. A computer readable recording medium in which a program for executing a method of operating a touch screen device which enables an entity to be shifted or copied based on a touch input is recorded, the method comprising:
when one or more entities positioned at a first point of an electronic document among a plurality of entities included in the electronic document displayed through a touch screen are selected by an entity selection command, and then a touch input of a user is applied onto a predetermined point of the one or more entities, detecting the touch input and tracking a shift trace of the touch input;
storing data for the one or more entities in a temporary storage space in a memory allocated for shifting and copying the data, and then confirming a second point, at which the shift of the touch input in the electronic document ends, based on the shift trace of the touch input; and
extracting the data for the one or more entities from the temporary storage space of the memory and inserting the one or more entities to the second point in the electronic document.

16. (canceled)
